(19) United States
(12) Patent Application Publication
(10) Pub. No.: US 2006/0047413 A1
(43) Pub. Date: Mar. 2, 2006

(54) GNSS navigation solution integrity in non-controlled environments

(76) Inventors: Nestor Zarraoa Lopez, Tres Cantos-Madrid (ES); Juan Ramon Martin Piedelobo, Tres Cantos-Madrid (ES); Manuel Toledo Lopez, Tres Cantos-Madrid (ES); Joaquin Cosmen Schortmann, Tres Cantos-Madrid (ES)

Correspondence Address: Sanchelima and Associates, P.A.;Jesus Sanchelima, Esq., 235 S.W. Le Jeune Rd., Miami, FL, 33134, US

(21) Appl. No.: 11/002,853

(22) Filed: Dec. 2, 2004

Related U.S. Application Data
(60) Provisional application No. 60/526,314, filed on Dec. 2, 2003.

(51) Int. Cl. G01C 21/36

(52) U.S. Cl. 701/200; 701/213

(57) ABSTRACT

The present invention consists of a method to ensure the integrity of the navigation solution even when the user is in a non controlled environment as it is the case of urban and road applications. The method requires the existence of a Signal In Space with guaranteed integrity as the one today provided by SBAS systems or from GBAS, Galileo or GPS-III in the future. The invention covers the algorithms to detect and isolate errors present in non controlled environments such as multipath and compute resulting position error bounds with the required level of integrity. This invention substantially increases the field of application of satellite navigation systems with associated integrity to the so-called liability critical applications.

### REFERENCES CITED

[RD.1] Minimum Operational Performance Standards for Global Positioning System/Wide Area Augmentation System Airborne Equipment, RTCA/DO-229C, 28/11/2001
[RD.2] Y. C. Lee, K. L. Van Dyke, Analysis Performed in Support of the Ad-Hoc Working Group of RTCA SC-159 on RAIM/FDE Issues, in Proc. National Technical Meeting ION, ION NTM 2002, January 2002
[RD.3] Weighted RAIM for Precision Approach, T. Walter, P. Enge, ION GPS, 1995
[RD.4] Navstar GPS User Equipment Introduction, 1996
[RD.5] Integrity Measure for Assisted GPS Based on Weighted Dilution of Precision, H. Sairo, J. Syrjärinne, J. Lepäkoski and J. Takala, ION GPS 2002, September 2002
[RD.6] Solution of the Two Failure GPS RAIM Problem Under worst Case Bias Conditions: Parity Space Approach, R. Grover Brown, NAVIGATION, Vol. 44, No. 4, Winter 1997-98.

### FIELD OF THE INVENTION

The present invention relates to methods and algorithms for implementing in future Global Navigation Satellite Systems (GNSS) receivers and/or GNSS-based applications in order to ensure the integrity of the provided navigation solution even when the user is in non-controlled environments such as urban areas or roads.

The Method pays special attention to the detection and exclusion of measurements either with large multipath or subject to reflections that invalidates the main assumptions required for the computation of Protection Levels derived from a GNSS system with guaranteed signal integrity (as it is the case of SBAS and Galileo and/or GPS III in the future).

Present invention can be applied in a wide diversity of fields, whenever position/velocity information is used between parties with liability (either legal, administrative or economical) implications. Examples of those so-called liability critical applications are
Position dependant billing systems: Applications for automatic tolling, road pricing, congestion control, zone fees, city parking tolling, etc. The system described guarantees that position derived billing is based upon information which error is bounded. Thus probability to have billing claims due to out of bounds errors is controlled to required level.
Position dependant law enforcement systems: Whenever position and velocity information is used as evidence with legal implications the system described guarantees involved parties a error-bounded position evidence. This can be for instance applied for traffic law enforcement as well as surveillance of parolees.
Position dependant taxes collection: Whenever position, velocity and time information is used as the basis for taxes collection for instance for road and urban environments where specific taxes policies can be implemented.
Fleet Management Systems: Fleet Management System where position is recorded and used as evidence to solve disputes with clients or employees. The system described provides an error-bounded position evidence.

All those applications have in common that not bounded navigation errors could imply errors with direct impact in commercial or legal aspects. E.g. erroneous charging for the use of certain infrastructure (in the case of road pricing) or erroneous fine for speeding in the case of traffic law enforcement applications).

### DISCUSSION OF THE RELATED ART

Methods and algorithms for computing integrity of the user navigation solution are today largely available based on both RAIM algorithms and information provided by the GNSS Signals (e.g. computation of Protection Levels based on the information provided by the SBAS Signal in Space according to SBAS MOPS). The reference in the aeronautical field as navigation and integrity algorithms that we will consider as basis for innovation, will be the SBAS navigation (EGNOS in Europe and WAAS in United States), which follows the MOPS standard ([RD.1]) for navigation and integrity, in particular for the Precission Approach modes when the integrity of the navigation solution is checked or validated by a parallel RAIM algorithm. While the MOPS standard does not describes a particular RAIM algorithm, we will consider as reference the weighted RAIM for SBAS precission approach navigation described by [RD.3].

Major limitations of the existing methods are that they are based on certain assumptions that while valid for some applications (e.g. in Civil Aviation) they cannot be verified when receiver is working in non controlled environments, as it is the case of urban and, in general, terrestrial applications.

Such assumptions are based on a-priori information on the quality of the measurements, which is not cross-checked with the real conditions measured by the receiver and which do not take into account the effect of uncontrolled error sources. This is the case of the standard RAIM technology that is being widely used with standardized specifications in the aeronautical field. This technique implies a set of assumptions that are valid in the aeronautical field including:
RAIM algorithms make the assumption of the single failure: only one measurement in view will fail, while the other measurements have a nominal behaviour. The source of the single failure is assumed to be a failure of one satellite transmitting the signal, an enough scarcely event to happen only to a single satellite
The nominal behaviour is characterised “a priori” by a noise level in the Satellites Navigation pseudorange measurements. This “a priori” noise level correspond to a permanent measurements model noise that characterizes the clean scenario. In GPS, before year 2000 this model corresponded to the Selective Availability as the dominant noise, having all the satellites a noise level of about 30 m. Since year 2000 the pseudorange measurements have reduced their noise level drastically to low values but function of the elevation and other parameters. The “a priori” measurement noise model of GPS case can be found in [RD.2], while the “a priori” measurement noise model of the case with SBAS corrections is described in [RD.1]

These two hypotheses are not applicable in the urban and road environments. In these scenarios, the dominant sources of errors in the satellite measurements are the local effects, in the vicinity of the receiver, mainly the multipath and the direct reflected signals (tropospheric errors are already accounted in the mentioned MOPS standard). In contrast to the scarcely single satellite failure, this effect acts continuously over several satellites, with a very variable error magnitude up to tenths of meters. This makes the single failure hypothesis and the “a priori” pseudorange measurements noise model not applicable.

In urban environment two types of main errors have to be considered: the multipath¹ properly said where signal composed of the direct and the reflected signals and the also common case of receiving only a reflected signal. The mitigation methods at HW level in high performances receivers are being highly effective for the composed signal (multipath) while can not detect the case of only reflected signal. In addition, the pseudorange smoothing methods are also able to damp partially the multipath in the composed signal taking advantage of the different behaviour of the carrier phase and the pseudorange observables. However for the only reflected signal the pseudorange and carrier phase are consistent and these pseudorange smoothing filters are not applicable.
¹For the sake of simplification the term multipath is used along this document to cover this effect and also the reception of only the reflected signal. Whenever necessary the term will be characterized to refer to one or the other effect

Other factor to be considered is the different multipath behaviour depending on the receiver dynamics. In static receivers both types of multipath are perceived in first approach as bias, while the receiver dynamics makes that the composed multipath is seen in first approach as noise (measurements in locations more distant than one wave-length are de-correlated) and in the case of the only reflected signal, the Doppler effect due to the projection of the receiver velocity in the signal path is different than in the line of sight of the expected nominal signal. Proposed method considers then the user velocity as a variable for the integrity algorithm.

Moreover current methods are focused on safety critical applications what implies that real time solution (integrity assessed every epoch for each computed navigation solution and delivered at that epoch) and not use of sequential filters are a must.

Maps data integrity is still an open issue what implies that map-matching technologies cannot be used as a means for improving solution integrity.

All those limitations of the state of the art precludes the GNSS applications for the so called “liability critical applications” in non controlled environments.

### SUMMARY OF THE INVENTION

The presented innovation consists basically on the extension of the navigation integrity, fully developed for the aeronautical field, to the terrestial field with the urban and road environments as reference scenario. This extension requires a set of modifications and innovations in the navigation and integrity algorithms to deal with multiple potential sources of error in the measurements affecting to several satellites measurement simultaneously, instead of the clean aeronautical environment where the dominant error source are the satellite ephemeris and clock errors and the ionospheric errors and those error sources are properly bounded as part of the integrity services (e.g. UDRE and GIVE in the SBAS standard).

The SBAS systems, currently implemented by EGNOS in Europe and by WAAS in United States, are an overlay to GPS that determines the integrity of the GPS satellites at signal in space (SIS) level, at the same time that corrections to the pseudoranges are provided for an improved navigation accuracy. Therefore the SBAS systems provides the mentioned bounds and informs to the user receiver about which are the healthy satellites that can be used for positioning and GARAI will be using measurements of satellites with due SBAS integrity.

The remaining sources of errors in the measurements will be the local effects, usually dominated by the multipath. The SBAS navigation solution and integrity algorithms use a pseudorange measurement noise model defined in the Appendix J of [RD.1] for each i-satellite as:
σᵢ²=σ_{i,flt}²+σ_{i,UIRE}²+σ_{i,air}²+σ_{i,tropo}²

where the different terms are:
σ_{i,flt}² model variance for the fast and slow long term corrections residual error.
σ_{i,UIRE}² model variance for the slant range ionospheric correction residual error.
σ_{i,air}² model variance of the airborne receiver errors, which is composed of the terms:
   σ_{i,air}²=σ_{i,noise}²+σ_{i,multipath}²+σ_{i,divg}²
σ_{i,noise}²: Variance of a normal distribution that bounds the errors in the tails of the distribution associated with the GNSS receiver for satellite i, including receiver noise, thermal noise, interference, inter-channel biases, extrapolation, time since smoothing filter initialization, and processing errors.
σ_{i,multipath}²: Variance of the zero mean normal distribution of the airborne equipment multipath error, function of the satellite line of sight elevation angle.
σ_{i,divg}²: Variance of the differentially-corrected pseudorange error induced by the steady-state effects of the airborne smoothing filter, given the ionospheric divergence, due to the evolution of the slant delay evolution with the time.

σ_{i,tropo}² model variance of the residual error for equipments that apply the tropospheric delay model described in the MOPS.

In urban environment this model, with the information broadcast by SBAS systems and by the GPS messages, is yet valid for the SIS level terms (Fast and slow long terms, ionospheric and tropospheric delay terms) and the receiver hardware noise term σ_{i,noise}², but the local effects, dominated by the non controlled multipath, will follow a totally different statistic than the clean background multipath environment considered in the MOPS specification. There are two approaches to manage this effect that will be used simultaneously in GARAI:
Those pseudorange measurements with very large range errors will be rejected.
The variance of the pseudorange measurements noise, dominated by the multipath, σ_{i,multipath}², will be characterised each epoch, using the measurements.

Our innovation takes advantage of the behaviour of the different types of multipath (composed direct plus reflected signal and only reflected signal) in presence of the receiver dynamics to develop efficient methods to reject degraded measurements and to characterise the measurements noise with σ_{i,multipath}² for navigation. The receiver dynamics makes that the composed signal with multipath is seen in first approach as noise (measurements in locations more distant than one wave-length are de-correlated) and in the case of the only reflected signal, the Doppler effect due to the projection of the receiver velocity in the signal path is different than in the line of sight of the expected nominal signal.

A possible but non exclusive implementation of these ideas in a new approach to the computation of the positioning integrity in non controlled environments (like the urban case) is summarised in the following paragraphs. This new approach is an enhanced RAIM algorithm that includes new and modified characteristics over the classical approach:
The pseudorange step detector, as basic method to screen out failing measurements in the traditional approach, is replaced by a more exhaustive pre-processing for measurement characterisation, with the twofold objective of rejecting the pseudoranges with large errors and to characterise the properties of the pseudorange measurements susceptible of being used for navigation.
Mitigation and rejection methods of the only reflected signal is achieved based on the following steps:
   Carrier Phase pre-processing. The classical RAIM algorithms for positioning are based on the pseudorange measurements. We introduce here the use of the carrier phase measurements, the computation of receiver velocity and this same receiver velocity as resources to screen out with a configurable confidence level the erroneous measurements.
   Carrier Phase RAIM. As part of the pre-processing stage the RAIM algorithm is adapted to be applied on the Least Squares on the Carrier Phase measurements to compute the vector of position change between measurement epochs, or velocity vector. Due to the small noise of the nominal Carrier Phase measurements, in the order of several milimeters or the centimeter level, this test provides a high observability on carrier phase inconsistencies. This is more evident in the case of the only reflected signal that follows a path totally different from the nominal, what makes it being affected by the Doppler effect in a totally different amount.
Multipath characterisation. Mitigation and rejection methods of the signal composed of direct and reflected components:
   Pseudoranges smoothing and Error variance estimation. The stage of pseudoranges smoothing with carrier phase is enhanced to serve for multiple puposes: smoothing of psudoranges, characterisation of the noise of the raw and smoothed pseudoranges, plausibility test on raw pseudoranges and rough multipath detector. This method is specially effective with receiver motion over the signal with multipath, composed of direct and reflected signal.
Pseudoranges weight update. The noise measured in the smoothed pseudoranges will fed the adaptative pseudorange noise model identified above in [0022] to compute the pseudoranges weight matrix to be used in the navigation and the RAIM based Protections level computation.
Navigation and integrity with RAIM:
   The “a priori” model fixed pseudorange measurement weight matrix used in the navigation and RAIM algorithms, specified in [RD.1], is replaced by the adaptative Pseudoranges weight matrix updated each epoch.
   The Protection Levels, based in the weighted RAIM single failure detection described in [RD.3], are enhanced to be computed in any multiple failure condition. The computation of these Protection Levels in any generic multiple failure case is a generalisation of the development for the double failure case described in [RD.6].

The result of all these innovative enhancements to the current RAIM schemes will allow on one hand to screen out the measurements with large errors from the computation of the positioning, on the other hand to properly characterize the pseudoranges to be used for positioning, and finally, with this consistent information of the pseudorange characteristics, the adaptative RAIM algorithm in position will determine the protection level of the computed poisition with the required integrity or confidence Level.

### BRIEF DESCRIPTION OF THE DRAWINGS

FIG. 1 illustrates the overall algorithms architecture, which can be used to implement one embodiment, identifying the main components, and in particular highlighting the claimed innovations in the present invention.

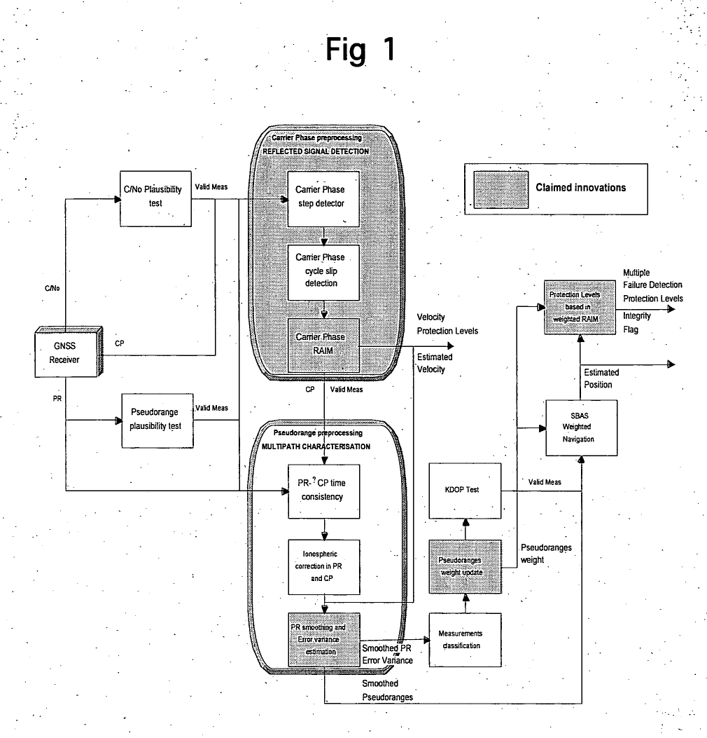

### DETAILED DESCRIPTION OF THE PREFERRED EMBODIMENTS

Reference will now be made in detail to the embodiment of the invention, a method for guaranteeing the integrity of the navigation solution in non-controlled environments based on the service integrity included in a GNSS Signal in Space (from SBAS system today and GBAS, Galileo and GPS-III in the future). While the invention will be described in conjunction with the preferred embodiments, it will be understood that they are not intended to limit the invention to these embodiments.

The objective of the proposed methods is the computation of the navigation solution (position, velocity and/or time) error bounds (also known as Protection levels in the civil aviation world) that guarantees the required level of integrity, i.e. that ensures that the probability of the error being larger than the mentioned error bound is below certain probability, and also the computation of a flag of validity of the navigation and integrity outputs.

Method ensures the validity of the mentioned Protection Levels even in case that the user is in a non controlled environment. Integrity is taken priority w.r.t. solution availability what implies that conservative mechanisms are implemented to identify and reject measurements or position and integrity outputs suspicious to have large errors.

Invented method includes specific algorithms that detects situations with measurements that can be subject to excessive multipath errors in such a way that if they can be identified then they are not considered in the computation of the navigation solution, or if they can not be identified the navigation and integrity solution is invalidated.

Invented method generalises the computation of the error bounds as defined today in the corresponding RTCA MOPS (based on the assumption of a controlled environment, in particular with reduced multipath) to a non-controlled environment by screening out suspicious wrong measurements, using only not rejected measurements and including additional margins for the computation of protection levels to account for residual multipath errors.

The invented method consists on a pre-processing, preceding the position and integrity computation, that will be responsible for the characterisation of pseudoranges and of a first set of measurements rejections. Later, for navigation and integrity computation, a RAIM scheme will be used, what will allow a final rejection of not properly characterised pseudoranges. For this purpose a weighted RAIM algorithm will be used.

The corresponding algorithms consists of the following steps that are individually described in the following paragraphs. Detailed description is later provided for those new algorithms that are specific part of this invention.

1) Preprocessing:
General Preprocessing:
   Carrier to noise plausibility test
   Pseudorange plausibility test
Carrier Phase preprocessing:
   Carrier phase step detector
   Carrier phase cycle slip detector
   Carrier phase RAIM [invention]
Pseudorange preprocessing:
   Pseudorange verus carrier phase time consistency test
   Ionospheric correction for pseudorange and carrier phase
   Pseudorange smoothing and error variance estimation [invention]
Measurement classification

2) Navigation and integrity computation:
Pseudoranges weight update [invention]
KDOP test
SBAS weighted navigation
Protection level computation based on weighted RAIM for multiple failure case [invention]
   Preprocesssing:

General Preprocessing:
Carrier to noise plausibility test. Nominally the C/N0 of the received signal depends of the satellite elevation and secondarily of the satellite broadcast power and of the receiver antenna gain pattern. A threshold of minimum allowed C/No as function of the satellite elevation will allow to reject those satellites with signal power atenuated by trees canopy or by multipath with the carrier of the reflected signal in opossite phase. The threshold as function of the elevation can be calibrated continuously with the measured C/No for the satellites in view with the maximum elevation.
Pseudorange plausibility test. Pseudorange plausibility check, on the values of the full pseudoranges. The approach for this algorithm relies on the computation of predicted ranging measurements which are more or less accurate, based on the information coming previous epochs and the navigation messages broadcast by the satellites applied to the time when the plausibility has to be checked.

Carrier Phase Preprocessing:
Carrier phase step detector. With the last estimation of receiver position and velocity, receiver and satellites clock bias and drift, and the last and the current satellite position and velocity, ranges of plausible carrier phases measurements of all the satellites can be estimated. This allows to reject all the measurements of those satellites with highly deviated Carrier Phases.
Carrier phase cycle slip detector. The purpose of this algorithm is to detect discontinuities in the carrier phase measurements due to cycle slips. No attempt will be made to repair the cycle slips and thus only a detection flag for each active satellite will be provided. The proposed algorithm is based on the generation of a predicted carrier phase measurement for the current epoch based on the last ones, and the comparison with the incoming carrier phase. If the difference between both is greater than a certain threshold, then it is considered that there has been a cycle slip, and the filter is therefore reset. Additionally the receiver clock stability is not assumed to be good, and consequently a mechanism has to be implemented in order to avoid considering a clock jump as a cycle slip. This is based on the fact that the clock jump appears in all the measurements as a cycle slip of the same magnitude, assuming that the short-term stability of the code and phase interchannel bias is sufficiently good.
Carrier phase RAIM [invention]. RAIM in the accumulated carrier phase between measurement epochs. The objective is twofold: to check the consistency between the carrier phase measurements in one epoch and to estimate the increment of postion between measurement epochs, or velocity, of the receiver. The formulation of the RAIM algorithms for positioning with pseudoranges, like the weighted RAIM algorithm described in [RD.3], is applicable redefining the state vector, the input data, and the RAIM parameters.

The state vector, receiver position vector and clock bias, is replaced by the receiver increment of position and clock drift between measurement epochs.

As input data, the following modifications have to be made:
As measurements, the pseudoranges are replaced by the accummulated carrier phase between the previous and the current epoch.
The measurement noise, used to build the weight matrixes, is now defined by the noise of the “a priori” nominal accummulated carrier phase measurement, which depending on the receiver can vary from a few milimeters to about two centimeters.
The observation matrix, named G in [RD.3], will be, as usual, the partial derivate of the measurement equation with respect to the state vector. As the measurements and state vector are now different than in the classical positioning RAIM with pseudoranges the observation matrix will have a very different expresion.

The main RAIM parameter, the threshold for the valid quadratic sum of measurements residuals, will have to be scaled to the values and units of the measurement noise considered now, but keeping the False Alert and Missdetection probabilities.

Pseudorange Preprocessing:
Pseudorange verus carrier phase time consistency test. The pseudorange validation is based on the comparison between the pseudorange temporal evolution and the carrier phase temporal evolution, provided that no cycle slip has occurred, what has been tested above. If the difference is greater than a given threshold, then the new incoming pseudorange measurement is rejected. If this happens, the previous carrier phase and pseudorange are held internally for the comparison in the next epoch. This check may be reset by two reasons: either there has been a detected cycle slip, or the number of consecutive rejected pseudorange measurements is sufficiently high so as to have a significant code/carrier divergence due to the evolution of the ionospheric delay.
Ionospheric correction for pseudorange and carrier phase. The objective of this algorithm is to estimate the ionospheric delay and correct the ranging measurements. It will also provide the uncertainty of the correction in terms of the variance of the residual error. The computation of the ionospheric delay will be performed according to the approach defined in appendix A of MOPS (see reference [RD.1] for additional details). The SBAS systems broadcast the vertical ionospheric delays for a predefined set of grid points (IGP), as well as the estimated variance for the residual error. The first step is to computed for each active satellite the position of the corresponding Ionospheric Pierce Point (IPP), which is the intersection between the satellite-to-user Line of Sight (LOS) and an ellipsoid with constant height of 350 km above the reference system ellipsoid; then the surrounding IGPs are identified, and the user ionospheric vertical delay together with the associated error variance are obtained by means of an interpolation scheme according to [RD.1]. Finally the slant values are generated using an obliquity factor which is a function of the satellite elevation.

Note that the pseudorange smoothing algorithm will compute a non-integer carrier phase ambiguity based on the comparison of the iono-free pseudorange and carrier phase measurements. It is assumed that the error in the ionospheric correction will not change during the time interval of measurements considered for smoothing. If this assumption is not considered, the error variance provided by this algorithm should be enlarged to account for this effect.
Pseudorange smoothing and error variance estimation [invention]. The aim of this function is to interpolate the pseudorange measurements to an intermediate epoch in the measurements time span, based on the comparison with the carrier phase ones, in order to minimise the impact of the receiver noise and multipath. An estimation of the variance of the residual error will be also provided, for its use later on to weight the measurements in the in user position and protection level computation.

The fundamentals of the pseudorange smoothing are quite simple. For each epoch, the difference between the iono-free pseudorange and carrier phase measurements is a noisy estimation of the ambiguity (a non-integer value is searched for, since the residual errors and the possible biases between both type of measurements do not allow a precise ambiguity resolution). Unless there is a cycle slip in the carrier phase, what is checked above, the ambiguity obtained at each epoch should be the same except for the noise. Thus averaging the snapshot estimated ambiguities for a time interval will decrease the residual error. Note also that the Hatch filter could be used as an alternative to this moving average scheme.

Some additional considerations have to be made prior to obtain the full picture in an enhanced algorithm. This RAIM algorithm for non-controlled environments is intended for both pedestrian and vehicle users that normally move, but also in static conditions. High-level multipath will be experienced in these conditions, although the values will evolve rapidly for a dynamic user, as long as the relative position of the user, the satellite and the reflectors changes. However, for a static user, the multipath will evolve quite slowly because the reflectors are assumed to be very close to the user (between few metres and several tens), and thus it will be perceived approximately as a bias for several hundreds of seconds. Consequently a specific mechanism has been defined to minimise the pseudorange noise in the static case using the information of the user velocity.

The main steps of the algorithm are the following:

1. For each active satellite “i”, compute the snapshot carrier phase non-integer ambiguity, comparing the iono-free pseudorange and carrier phase measurements for the current epoch:
Nᵢ(tₖ)=ρ_{i,iono-free}(tₖ)−Φ_{i,iono-free}(tₖ)

2. If there has been a cycle slip, reset the filter.

3. Update the buffer of ambiguities by removing the oldest one (if the buffer is full) and adding the previously computed ambiguity. If the number of ambiguities is above a certain minimum number, compute the averages ( ) for the short-term and long-term filters (N_{i,average,short}(tₖ) and N_{i,average,long}(tₖ) respectively) together with the associated residual covariance (S_{i,short}²(tₖ) and S_{i,long}²(tₖ) respectively):

$$\begin{matrix}{N}_{i , average , short} ( {t}_{k} ) = \frac{1}{{M}_{1}} {\sum }_{l = 0}^{{M}_{1} - 1} {N}_{i} ( {t}_{k - 1} ) \\ {S}_{i , short}^{2} ( {t}_{k} ) = \frac{1}{{M}_{1} - 1} {\sum }_{l = 0}^{{M}_{1} - 1} ( {N}_{i} ( {t}_{k - 1} ) - {N}_{i , average , short} ( {t}_{k} ) ) \\ {N}_{i , average , long} ( {t}_{k} ) = \frac{1}{{M}_{2}} {\sum }_{l = 0}^{{M}_{2} - 1} {N}_{i} ( {t}_{k - 1} ) \\ {S}_{i , long}^{2} ( {t}_{k} ) = \frac{1}{{M}_{2} - 1} {\sum }_{l = 0}^{{M}_{2} - 1} ( {N}_{i} ( {t}_{k - 1} ) - {N}_{i , average , long} ( {t}_{k} ) )\end{matrix}$$

Note that M₁ and M₂ will be in the order of 100 and 600 seconds respectively.

4. For each filter and for each snapshot ambiguity, if the difference between it and the average is greater than three times the corresponding standard deviation, then reject the snapshot ambiguity and compute again the averages and the covariance. Repeat this process until no rejection is performed.

5. If the user velocity is above a certain minimum value and the time passed since this condition is met is greater than M₂, then the smoothed pseudorange (\tilde{ρ}_{i,iono-free}(tₖ)) and the associated residual noise (σ_{i,noise}²(tₖ)) is the following:

$$\begin{matrix}{\tilde{ρ}}_{i , iono - free} ( {t}_{k} ) = {N}_{i , average , long} ( {t}_{k} ) + {Φ}_{i , iono - free} ( {t}_{k} ) \\ {σ}_{i , noise}^{2} ( {t}_{k} ) = \frac{1}{{M}_{2}} \cdot {( {S}_{i , noise} ( {t}_{k} ) \cdot \frac{{t}_{P - 1 , md}}{{K}_{N , md}} )}^{2}\end{matrix}$$

where:
t_{n-n-1,md} is the point of the t-Student distribution with “P-1” degrees of freedom that leaves in the tails (two-tail problem) a probability equal to the missed detection probability assigned to the whole RAIM algorithm. The number of independent samples could be computed by means of computing the autocorrelation function of the residuals with respect to the averaged ambiguity;
K_{N,md} is the point of the Gaussian distribution (zero mean and variance equal to 1) that leaves in the tails (two-tail) problem a probability equal to the missed detection probability assigned to the whole RAIM algorithm;

6. If the user velocity is below a certain minimum, then the output of the short-term filter should be used to build the smoothed pseudorange correcting it with the difference between the output of both filters when the velocity was equal to the minimum. In the transition time between both situations, a smoothed variation scheme will take place.

Measurement classification. The measurements classification, to determine the usability for navigation and integrity comprises the following steps:
Ranking ordering of the preprocessed measurements according to their characterisation, from better to worst
Rejection of those measurements labeled for rejection during the previous preprocessing. This step should be by-passed in case of lack of enough measurements for computing the navigation solution. There must be available at least the same number of pseudorange measurements than the state vector dimension.
Measurements selection: In this stage not all the non rejected measurements have to be used for navigation and integrity. As the characterisation of the measurements could have not been perfect, in particular in the case of the worst measuremements with larger errors, is better to use the minimum set of the best measurements being enough for the expected performances.
   Navigation and Integrity Computation

Pseudoranges weight update [invention]. The variance of the noise of each pseudorange i will be computed according to the equation in MOPS specification [RD.1], updating the multipath term with the characterisation from the Pseudorange smoothing and error variance estimation step above.
σᵢ²=σ_{i,flt}²+σ_{i,UIRE}²+σ_{i,air}²+σ_{i,tropo}²
σ_{i,air}²=σ_{i,noise}²+σ_{i,multipath}²+σ_{i,divg}²

And the weight matrix, W, is built as:

$${W}^{- 1} = [ \begin{matrix}{σ}_{1}^{2} & 0 & … & 0 \\ 0 & {σ}_{2}^{2} & … & 0 \\ ⋮ & ⋮ & ⋰ & ⋮ \\ 0 & 0 & … & {σ}_{N}^{2}\end{matrix} ]$$

KDOP test. The objective of this test is to determine for which measurments an error in the pseudorange characterisation can have a negative effect in the positioning error, in order to exclude them from the final set of measurements to be used for navigation and integrity. KDOP definition is found in [RD.4]. The test computes a weighted DOP, comparing the pseudoranges weights in an “a priori” pseudorange noise model with the updated pseudoranges weight.

$$\begin{matrix}{H}^{′ *} = ( {H}^{T} {W}^{′} H ) {H}^{T} {W}^{′} \\ D = {H}^{′ *} {W}^{- 1} {H}^{′ * T} \\ = KDOP \sqrt{trace ( D )}\end{matrix}$$

Where:

W′ “a priori” weight matrix

W Updated current weight matrix

KDOP is computed for the set of N measurements and for all the N-1 subsets: Those measurements that make the N set to have worst KDOP than the N-1 subset exluding that measurement will be rejected for further processing.

The test will be repeated until that the test is passed or until that there is at least one redundant measurement to allow to aply RAIM.

The case considering W′=I is described in the literature ([RD.5]), where the D matrix used for KDOP yields to:
D=(H^{T}H)⁻¹H^{T}W⁻¹H(H^{T}H)⁻¹
while here we are considering an enhanced non simplified expresion in order take into account in W the reliable available SBAS information.

SBAS weighted navigation and Protection level computation based on weighted RAIM for multiple failure case [invention]. The navigation and integrity will use only those smoothed pseudoranges corresponding to satellites that have not been rejected in any of the previous tests. The MOPS specification scheme for PA with a RAIM algorithm in parallel ([RD.1], section 2.1.5 “Requirements for APV-II and GLS Precision Approach Operations”), will be used for positioning and integrity with the following modifications:
Use of the updated pseudorange weight, instead of the “a priori” MOPS model
There must be at least 1 redundant measurement over the state vector dimension, in order to check the positioning solution with the RAIM FD test.
The PL's will be computed either for the case of single failure or for the multiple failure case, depending on the final application. The case of computation of Protection Levels in case of double failure is described in [RD.6]. We have available the demonstrataion for the generalized problem with multiple failure.

The classical expresion of the Protection Levels is obtained maximizing the error in the elements of the state vector due to the failure in one measurement that yields to an increment in the Chi-squared test statistic on the measurements residuals to detect failures. This demonstration has to be enhanced to consider a multiple failure. This is made introducing additional constraints in the problem to be maximized.
One constraint consisting in that the multiple failure yields to a constant value of the chi squared test.
A second constraint consists in defining the failure mode. From all the possible combinations of satellites, only the combinuations of any given number M of satellites is allowed.

These two additional constraints introduce a generalized optimisation problem with constraints to be managed with Lagrange mathematical techniques.

The final results of the GARAI algorithm for the end user will be:
Positioning solution,
Associated RAIM PL values
Integrity flag corresponding to the RAIM FD test for the set of measurements used in positioning
Velocity vector, resultant of the RAIM applied to the Carrier Phase measurements.

Depending of the intended final service, and considering the velocity vector, the PL can be expressed as:
One global horizontal PL
Cross track PL, based in the velocity vector or in the known road lane vector.
Comparison of the PL with any rectangular limit area:

The foregoing descriptions of specific embodiments of the present invention have been presented for purposes of illustration and description. They are not intended to be exhaustive of to limit the invention to the precise forms disclosed, and obviously many modifications and variations are possible in light of the above teaching. The embodiments were chosen as described in order best to explain the principles of the invention and its paractical application, thereby to enable others skilled in the art best to utilize the invention and various embodiments with various modificationa as are suited to the particular use contemplated. It is intended that the scope of the invention be defined by the Claims appended hereto and their equivalents. All variations and modifications which are obvious to those skilled in the art to which the present invention pertains are considered to be within the scope of the protection granted by this Letters Patent.

We claim:

1. An algorithm called GARAI (GNSS-Aided Receiver Autonomous Integrity) that ensures the navigation solution integrity based on a GNSS signal with ensured service integrity based on SBAS and that is specifically designed to work in non-controlled environments such as urban areas or roads.

2. Same algorithm as in item 1 where signal integrity is provided by Galileo instead of by SBAS systems.

3. Same algorithm as in item 1 where signal integrity is provided by GBAS or other local integrity elements.

4. Same algorithm as in item 1 where signal integrity is provided by other GNSS systems as, potentially, GPS-III.

5. An algorithm to ensure detection and exclusion of reflected measurements and able to compute velocity and associated protection levels, this algorithm is an essential part of the mentioned GARAI algorithm.

6. Same algorithm as in item 5 where the algorithm (Carrier Phase RAIM) excludes multipath reflected measurements based o the inconsistencies among observed Doppler effect and velocity vector.

7. An algorithm that characterise the local pseudorange errors (multipath and receiver noise) in terms of associated variance, measurements with excessive multipath errors are excluded for later computations and multipath is mitigated in valid measurements, this algorithm is essential part of the mentioned GARAI algorithm.

8. Same algorithm as in item 7 where ionospheric errors are compensated based on two frequencies measurements instead of on SBAS provided ionospheric model.

9. Same algorithm as in item 7 where the smoothed pseudoranges are computed based on a real-time filter instead of on a sequential interpolation filter.

10. An algorithm that computes the weights of the pseudorrange errors based on the information computed by algorithm described in item 7, this algorithm is essential part of the mentioned GARAI algorithm.

11. An improved algorithm for computation of “Protection level computation based on weighted RAIM for multiple failure case”, this algorithm is essential part of the mentioned GARAI algorithm.

12. An algorithm as the one identified in item 12 where computation of integrity considers the vehicle velocity and does not compute solutions where vehicle has been stopped during a certain period of time.

13. An Enhanced Performance Integrity algorithm that allows improving the integrity and/or availability performance of the algorithms defined in item 1 by combining the computed position and protection levels with external GIS information related to roads and streets where this information has been checked to ensure its integrity.

14. An algorithm as the one identified in item 13 where external information is related to the topography of the surface (3D information).

15. An algorithm that allows improving the integrity and/or availability performance of the algorithm defined in item 1 where information from different mobile units located in a certain restricted area are combined to cross-check the quality of the provided measurements.
